(19) United States
(12) Patent Application Publication
(10) Pub. No.: US 2026/0121007 A1
(43) Pub. Date: Apr. 30, 2026

(54) DETECTOR

(71) Applicant: Hunan LingFeng Instrument Equipment Co.,LTD, Changsha (CN)

(72) Inventors: Yujun LIU, Changsha (CN); Cong ZHOU, Changsha (CN)

(73) Assignee: Hunan LingFeng Instrument Equipment Co.,LTD, Changsha (CN)

(21) Appl. No.: 19/430,345

(22) Filed: Dec. 23, 2025

Related U.S. Application Data
(63) Continuation of application No. PCT/CN2025/074343, filed on Jan. 23, 2025.

(30) Foreign Application Priority Data
Feb. 21, 2024 (CN) 202410194462.5

(51) Int. Cl. H01J 49/02; H01J 49/04

(52) U.S. Cl. CPC H01J 49/025; H01J 49/0445

(57) ABSTRACT

Disclosed is a detector (100), including an atomization mechanism (10), a charging mechanism (20), an ion trap (30), and an electrostatic detection mechanism (40). The atomization mechanism (10) is provided with an atomization cavity (11) and used for introducing a carrier gas and atomizing a sample. The charging mechanism (20) is provided with a charging cavity (21) and used for charging the detection gas flow. The ion trap (30) is provided with a separation cavity (31) and used for separating charges carried by the carrier gas. The electrostatic detection mechanism (40) is used for detecting the quantity of charges carried by the detection gas flow output from the ion trap (30). The atomization cavity (11), the charging cavity (21), and the separation cavity (31) are sequentially connected and communicated to form a detection gas path for the detection gas flow to flow.

### CROSS-REFERENCE TO RELATED APPLICATIONS

The application claims priority to Chinese patent application No. 202410194462.5, filed on Feb. 21, 2024, the entire contents of which are incorporated herein by reference.

### TECHNICAL FIELD

This disclosure relates to the technical field of instruments, and in particular, to a detector.

### BACKGROUND

One method for detecting the concentration of a target component in a sample solution is: atomizing the solution sample into small droplets, charging the small droplets through corona discharge or electrospray ionization to form charged particles after drying, and finally capturing the charged particles and measuring the quantity of charges using an electrostatic meter. The obtained signal is directly proportional to the quantity of the target components existing in the sample solution, thereby being capable of obtaining the concentration of the target component through calculation.

In the related art, gases used by such a system are divided into two paths: one path is a carrier gas that plays a role of two-fluid spraying (gas part) and carrying the sample into the collision cell, and the other path is a collision gas that plays a role of charging and charge transfer. This structure has several drawbacks: firstly, the introduction of the collision gas may cause the dilution of the aerosol containing the sample and peak broadening, resulting in decreased sensitivity; and secondly, the dual gas paths also increase the gas consumption.

### SUMMARY

In view of the above problems, it is necessary to provide a detector that can improve the sensitivity of detection and reduce the gas consumption.

A detector, including:
an atomization mechanism, provided with an atomization cavity and used for introducing a carrier gas and atomizing a sample, to form, in the atomization cavity, a detection gas flow containing an atomized sample;
a charging mechanism, disposed downstream of the atomization mechanism along a flow direction of the detection gas flow, provided with a charging cavity, and configured to charge the detection gas flow within the charging cavity;
an ion trap, disposed downstream of the charging mechanism along the flow direction of the detection gas flow, provided with a separation cavity, and used for separating charges carried by the carrier gas and solvent molecules, where the separated charges are neutralized upon collision with electrode surfaces; and
an electrostatic detection mechanism, disposed downstream of the ion trap along the flow direction of the detection gas flow, communicated with the separation cavity, and used for detecting a quantity of charges carried by the detection gas flow that is output from the ion trap and that contains a target component, where
the atomization cavity, the charging cavity, and the separation cavity are sequentially connected and communicated, to jointly form a detection gas path for the detection gas flow to flow.

In an embodiment, the charging mechanism includes a first electrode and a second electrode, the first electrode encloses to form the charging cavity, and the second electrode is at least partially disposed in the charging cavity and is spaced apart from the first electrode.

In an embodiment, the ion trap includes a third electrode and a fourth electrode, the third electrode encloses to form the separation cavity, and the fourth electrode is at least partially disposed in the separation cavity and is spaced apart from the third electrode.

In an embodiment, the detector further includes a cylinder, the cylinder includes a first segment and a second segment in an axial direction of the cylinder, the first segment is formed as the first electrode, and the second segment is formed as the third electrode.

In an embodiment, the cylinder is of a cylindrical shape, and the second electrode and the fourth electrode are both needle electrodes or rod electrodes and are both disposed along an axis of the cylinder.

In an embodiment, the detector is configured to selectively introduce positive or negative charges to the second electrode and the fourth electrode.

In an embodiment, the detector further includes a limiting member, and the limiting member is disposed between the charging cavity and the separation cavity in a blocked manner and provided with a limiting through hole communicated with the charging cavity and the separation cavity.

In an embodiment, the limiting member is provided with a flow guide channel, the flow guide channel is at least partially tapered in the flow direction of the detection gas flow, and the limiting through hole is formed at a tail end of the flow guide channel in the flow direction.

In an embodiment, the electrostatic detection mechanism includes a charge capturing structure, and the charge capturing structure is a metal powder sintered filter element.

In an embodiment, the detector further includes a drying tube, and the drying tube is disposed between the atomization mechanism and the charging mechanism, communicated with the atomization cavity and the charging cavity, and used for drying the detection gas flow flowing through the drying tube.

According to the above detector, the gas path is redesigned, and the purpose of detection is achieved through a single detection gas path only, thereby reducing the gas consumption. The degree of dilution of the sample by the carrier gas is also reduced naturally while reducing the gas consumption, peak narrowing is caused, and the sensitivity is improved. After being directly charged, the detection gas flow can directly enter the ion trap, the path of the detection gas flow is shortened, and the dead volume is reduced, so that the quantity of lost charges caused by the collision of the charged sample with the side wall is greatly reduced, which is also an important reason for the improved sensitivity.

### BRIEF DESCRIPTION OF THE DRAWINGS

To describe the technical solutions in the embodiments of this disclosure or in the prior art more clearly, the following will briefly introduce the accompanying drawings required for describing the embodiments or the prior art. Apparently, the accompanying drawings in the following description show only some embodiments of this disclosure, and those of ordinary skill in the art may still derive other drawings from these accompanying drawings without creative efforts.

FIG. 1 is a schematic structural diagram of a detector according to an embodiment of this disclosure;

FIG. 2 is a schematic diagram of a detection gas path in a detector shown in FIG. 1;

FIG. 3 is a chromatogram obtained when a detector shown in FIG. 1 detects a sample with a target component being fatty acid;

FIG. 4 is a chromatogram obtained when a detection solution in the related art detects a sample with a target component being fatty acid;

FIG. 5 is a chromatogram obtained when a detector shown in FIG. 1 detects a sample with a target component being notoginsenoside; and

FIG. 6 is a chromatogram obtained when a detection solution in the related art detects a sample with a target component being notoginsenoside.

Reference numerals in the accompanying drawings: 100. detector; 10. atomization mechanism; 11. atomization cavity; 20. charging mechanism; 21. charging cavity; 22. first electrode; 23. second electrode; 30. ion trap; 31. separation cavity; 32. third electrode; 33. fourth electrode; 40. electrostatic detection mechanism; 50. drying tube; 60. cylinder; 61. first segment; 62. second segment; 70. limiting member; 71. limiting through hole; 72. flow guide channel.

### DETAILED DESCRIPTION OF THE EMBODIMENTS

To make the above objectives, features, and advantages of this disclosure clearer and more comprehensible, the specific implementations of this disclosure are described in detail below with reference to the accompanying drawings. Many specific details are described in the following description to facilitate a thorough understanding of this disclosure. However, this disclosure can be implemented in many other manners other than those described herein, and those skilled in the art may make similar improvements without departing from the connotation of this disclosure. Therefore, this disclosure is not limited by the specific embodiments disclosed below.

In the description of this disclosure, it should be understood that if these terms such as “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, “axial”, “radial”, and “circumferential” appear, the orientations or positional relationships indicated by these terms are based on those shown in the accompanying drawings and intended only for the convenience of describing this disclosure and simplifying the description rather than for indicating or implying that the referred device or element must be provided with a particular orientation or constructed and operated with a particular orientation. Therefore, they should not be construed as limiting this disclosure.

In addition, if the term “and/or” appears, “and/or” is only an association relationship describing associated objects, indicating that there may be three relationships, for example, A and/or B may indicate the following three cases: A exists individually, A and B exist simultaneously, and B exists individually. In addition, the character “/” in the specification generally indicates an “or” relationship between contextually associated objects. Furthermore, if these terms “first” and “second” appear, these terms are intended only for descriptive purposes and should not be construed as indicating or implying relative importance or implicitly indicating the quantity of technical features indicated. Therefore, features defined by “first” and “second” may explicitly or implicitly include at least one of such features. In the description of this disclosure, if the term “a plurality of” appears, “a plurality of” refers to at least two, for example, two or three, unless otherwise explicitly and specifically defined.

In this disclosure, unless otherwise explicitly specified and limited, if the terms such as “mount”, “interconnect”, “connect”, and “fix” appear, these terms should be understood in a broad sense. For example, it may be a fixed connection, a detachable connection, or an integral connection; it may be a mechanical connection or an electrical connection; and it may be a direct connection, an indirect interconnection through an intermediate medium, or a communication between two elements or an interaction between two elements, unless otherwise explicitly defined. For those of ordinary skill in the art, the specific meanings of the above terms in this disclosure may be understood based on specific situations.

In this disclosure, unless otherwise explicitly specified and defined, if the similar descriptions such as a first feature being “above” or “below” a second feature appear, the meaning thereof may indicate a direct contact between the first and second features or an indirect contact between the first and second features through an intermediate medium. Furthermore, a first feature being “above”, “over”, or “on” a second feature may indicate that the first feature is directly or diagonally above the second feature, or only indicate that the first feature is higher in level than the second feature. A first feature being “below”, “beneath”, or “under” a second feature may indicate that the first feature is directly or diagonally below the second feature, or only indicate that the first feature is lower in level than the second feature.

It should be noted that if an element is referred to as being “fixed to” or “disposed on” another element, it may be directly positioned on another element or there may be a centered element. If an element is referred to as being “connected to” another element, it may be directly connected to the another element or there may be a centered element simultaneously. If any, the terms “vertical”, “horizontal”, “up”, “down”, “left”, “right”, and similar expressions used in this disclosure are for illustrative purposes only and do not represent the only implementation.

In addition to the problems in the background, the design of the dual gas paths in the related art may further have the following problems: a dual-gas-path structure needs to precisely control the magnitude of the two paths of gases, complicating the gas flow control and the gas path structure; the collision process also causes backmixing of some of the separated samples, leading to a decrease in the degree of separation, and the gas consumption can reach 4 L/min to 5 L/min; and the indirect charging manner involves first ionizing a nitrogen gas and then transferring the charge to the sample aerosol, which affects efficiency and ultimately sensitivity.

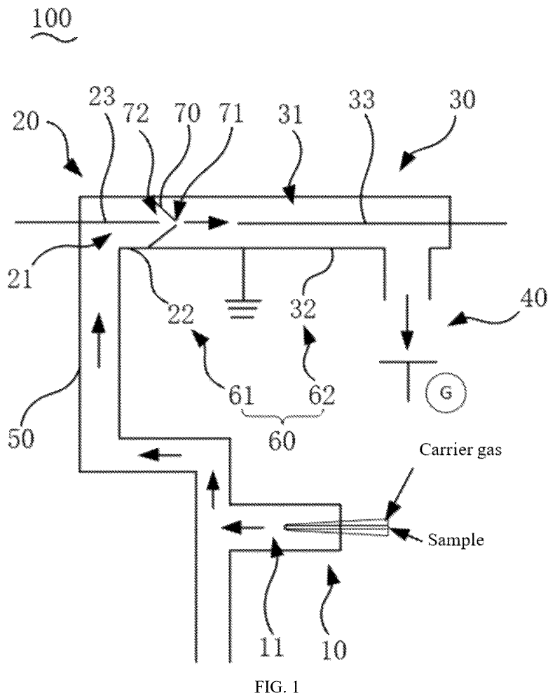

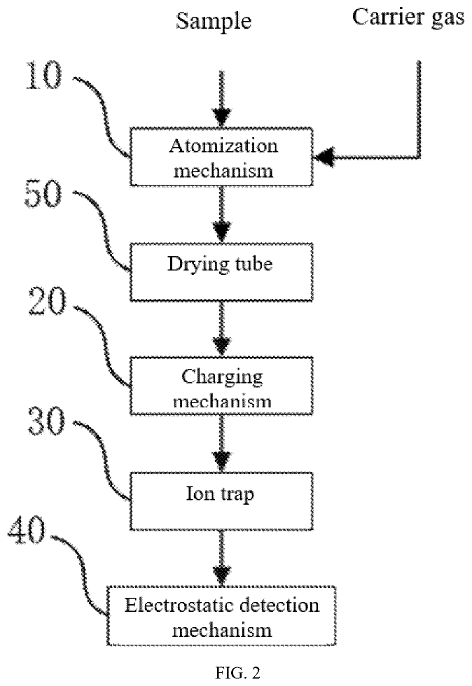

Referring to FIG. 1 and FIG. 2, an embodiment of this disclosure provides a detector 100, including an atomization mechanism 10, a charging mechanism 20, an ion trap 30, and an electrostatic detection mechanism 40.

The atomization mechanism 10 is provided with an atomization cavity 11 and used for introducing a carrier gas and atomizing a sample, to form, in the atomization cavity 11, a detection gas flow containing an atomized sample.

The sample may refer to a sample solution, which contains a target component. After being atomized, the target component flows with the carrier gas to form the detection gas flow, and the detection gas flow is an aerosol and includes the carrier gas, a solvent, and the target component. Specifically, the target component may be but is not limited to a nonvolatile solute. The carrier gas may be but is not limited to a nitrogen gas and the like, and the sample may be atomized in forms such as two-fluid spraying.

The charging mechanism 20 is disposed downstream of the atomization mechanism 10 along a flow direction of the detection gas flow, provided with a charging cavity 21, and configured to be capable of charging the detection gas flow in the charging cavity 21.

It may be understood that the charging mechanism 20 can receive the detection gas flow released by the atomization mechanism 10 downstream and charge the detection gas flow. Charging refers to charging particles in the detection gas flow, and charged particles include aerosol granules containing the target component, carrier gas molecules, and solvent molecules. Specifically, the charging may be implemented through discharging, and the forms of discharging may be glow discharging, corona discharging, dielectric barrier discharging, and the like.

The ion trap 30 is disposed downstream of the charging mechanism 20 along the flow direction of the detection gas flow, provided with a separation cavity 31, and used for separating charges carried by the carrier gas and solvent molecules in the detection gas flow in the separation cavity 31.

The ion trap 30 receives the detection gas flow charged by the charging mechanism 20 downstream and is configured to generate a trap electric field in the separation cavity 31. It is known that the molecular mass of the carrier gas molecules and the solvent molecules of the sample solution is much smaller than the mass of the aerosol granules containing the target component. For the charged carrier gas molecules, when passing through the trap electric field, the charged carrier gas molecules are significantly deflected under the action of an electric field force and eventually collide with a side wall, and the carried charges are transferred and neutralized, that is, the charges carried by the carrier gas and the solvent molecules are separated and captured by the ion trap 30. However, for the charged aerosol granules containing the target component, although the charged aerosol granules are also subjected to the electric field force when passing through the trap electric field, due to large mass and momentum thereof, deflection acceleration is much smaller than that of the charged carrier gas, and the deflection is not obvious, so that the charged aerosol granules can successfully pass through the trap electric field by following the neutral carrier gas.

The electrostatic detection mechanism 40 is disposed downstream of the ion trap 30 along the flow direction of the detection gas flow, communicated with the separation cavity 31, and used for detecting the quantity of charges carried by the detection gas flow that is output from the ion trap 30 and that contains the target component.

The electrostatic detection mechanism 40 receives the detection gas flow separated by the ion trap 30 downstream. As the charges carried by the carrier gas and the solvent molecules in the detection gas flow are separated by the ion trap 30, the electrostatic detection mechanism 40 can more accurately capture charges carried by the aerosol granules containing the target component in the detection gas flow, to determine the quantity of charges carried by all aerosols containing the target component. Since the detection gas flow is separated by the ion trap 30, the charges carried by the charged carrier gas molecules are transferred in advance. Therefore, the electrostatic detection mechanism 40 can more accurately capture the charges carried by the aerosol granules containing the target component, convert the charges into a voltage or current signal, and transmit the signal to host computer software, thereby determining a concentration of the target component in the sample solution.

The atomization cavity 11, the charging cavity 21, and the separation cavity 31 are sequentially connected and communicated, to jointly form a detection gas path for the detection gas flow to flow. The flow of the detection gas flow is shown by arrows in FIG. 1.

In a process from generation to arrival at the electrostatic detection mechanism 40 for detection, the detection gas flow flows in this single gas path: the detection gas path. Specifically, the detection gas flow is generated in the atomization cavity 11, flows into the downstream charging cavity 21 to be charged, and enters the electrostatic detection mechanism 40 to be detected after the charges of the carrier gas are separated by the separation cavity 31.

In an embodiment, the detector 100 may be but is not limited to a chromatographic detector or a charged aerosol detector (CAD).

According to the above detector 100, the gas path is redesigned, and the purpose of detection is achieved through a single detection gas path only, thereby reducing the gas consumption. The degree of dilution of the sample by the carrier gas is also reduced naturally while reducing the gas consumption, peak narrowing is caused, and the sensitivity is improved. After being directly charged, the detection gas flow may directly enter the ion trap 30, the path of the detection gas flow is shortened, and the dead volume is reduced, so that the quantity of lost charges caused by the collision of the charged sample with the side wall is greatly reduced, which is also an important reason for the improved sensitivity. In addition, the collision gas flow is eliminated, thereby greatly reducing the gas consumption while avoiding the problem of the decrease in the degree of separation caused by the backmixing that may result from collision charging. The design of the single gas path makes the structure of the detector 100 simpler, reduces gas control units, and decreases the control difficulty.

In some embodiments, the detector 100 further includes a drying tube 50, and the drying tube 50 is disposed between the atomization mechanism 10 and the charging mechanism 20, communicated with the atomization cavity 11 and the charging cavity 21, and used for drying the detection gas flow flowing through the drying tube to eliminate liquid water contained by the detection gas flow.

The drying tube 50 is disposed downstream of the atomization mechanism 10 along the flow direction of the detection gas flow and upstream of the charging mechanism 20. One end of the drying tube 50 is communicated with the atomization cavity 11, and the other end is communicated with the charging cavity 21. The detection gas flow flows into the charging cavity 21 after flowing into the drying tube 50 from the atomization cavity 11 and being dried.

The detector 100 performs charging after drying, so that the stability of charged migration in subsequent processes can be improved. In addition, the aerosol containing the target component can be further refined through a repulsive force of charge aggregation during charging.

In some embodiments, the charging mechanism 20 includes a first electrode 22 and a second electrode 23, the first electrode 22 encloses to form the charging cavity 21, and the second electrode 23 is at least partially disposed in the charging cavity 21 and is spaced apart from the first electrode 22.

The first electrode 22 and the second electrode 23 may be connected to opposite potentials, or the first electrode 22 may be grounded, and the second electrode 23 may be connected to a high-voltage positive potential or negative potential, etc. The polarities may also be switched as required, as long as a sufficient potential difference is formed between the first electrode 22 and the second electrode 23 to perform discharging and charge the detection gas flow, which is not specifically limited herein.

In this way, the detection gas flow enters the charging cavity 21 and can be in direct contact with a discharge needle, so that the charge conduction efficiency is greatly increased, and the proportion of charged granules containing the target component is increased.

Further, the ion trap 30 includes a third electrode 32 and a fourth electrode 33, the third electrode 32 encloses to form the separation cavity 31, and the fourth electrode 33 is at least partially disposed in the separation cavity 31 and is spaced apart from the third electrode 32.

The third electrode 32 and the fourth electrode 33 may be connected to opposite potentials, or the third electrode 32 may be grounded, and the fourth electrode 33 may be connected to a positive potential or negative potential, etc. The polarities may also be switched as required, as long as a sufficient potential difference is formed between the third electrode 32 and the fourth electrode 33 to form the trap electric field to separate the charges carried by the carrier gas, which is not specifically limited herein.

In this way, the trap electric field can be formed between the third electrode 32 and the fourth electrode 33, so that the charged particles in the detection gas flow entering a separator formed by the third electrode 32 can all be placed in the trap electric field and subjected to the electric field force, thereby fully deviating the charged carrier gas for separation and enabling the carrier gas to collide with the third electrode 32 to be neutralized.

Further, the detector 100 further includes a cylinder 60, the cylinder 60 includes a first segment 61 and a second segment 62 in an axial direction of the cylinder, the first segment 61 is formed as the first electrode 22, and the second segment 62 is formed as the third electrode 32.

It may be understood that the cylinder 60 may be made of conductive materials such as metal, which may be but is not limited to a cylindrical shape, a square cylindrical shape, and the like. Different segments of the cylinder in the axial direction of the cylinder are used for serving as the first electrode 22 and the third electrode 32 respectively. Therefore, that the cylinder 60 is grounded represents that the first electrode 22 and the third electrode 32 are grounded simultaneously.

In this way, the first electrode 22 and the third electrode 32 may be charged simultaneously, and the structure of the detector 100 is also simplified. The charging cavity 21 and the separation cavity 31 respectively formed by the first electrode 22 and the third electrode 32 correspond to different spatial regions in the cylinder 60. The detection gas flow may reach the separation cavity 31 from the charging cavity 21 by flowing in the cylinder 60, thereby greatly shortening the travel distance.

In some embodiments, the cylinder 60 is of a cylindrical shape, and the second electrode 23 and the fourth electrode 33 are both needle electrodes or rod electrodes and are both disposed along an axis of the cylinder 60.

The cylinder 60 is of the cylindrical shape, the second electrode 23 and the fourth electrode 33 are disposed along the axis of the cylinder 60, the first segment 61 of the cylinder 60 surrounds at least part of the second electrode 23, and the second segment 62 of the cylinder 60 surrounds at least part of the fourth electrode 33.

In this way, the second electrode 23 is formed as the needle electrode, which helps define an electric field line and reduce the discharging difficulty. The fourth electrode 33 is formed as the needle electrode, which can match the third electrode 32 that is of the cylindrical shape, to form a more uniform electric field.

In some embodiments, the detector 100 is configured to selectively introduce positive or negative charges to the second electrode 23 and the fourth electrode 33.

In other words, the second electrode 23 may be connected to the positive potential or the negative potential as required and can switch between the positive potential and the negative potential as required. Correspondingly, to satisfy the formation of a corresponding trap electric field, the fourth electrode 33 can also be connected to the positive potential or the negative potential as required and switch between the positive potential and the negative potential as required. Meanwhile, it may be understood that as a counter electrode of the second electrode 23, the first electrode 22 may be connected to an electrode with an opposite electrical polarity to the second electrode 23 or grounded, and as a counter electrode of the fourth electrode 33, the third electrode 32 may be connected to an electrode with an opposite electrical polarity to the fourth electrode 33 or grounded. When the first electrode 22 is connected to the opposite electrical polarity to the second electrode 23, and the third electrode 32 is connected to the opposite electrical polarity to the fourth electrode 33, after the second electrode 23 and the fourth electrode 33 change attributes of the connected electrodes, the first electrode 22 and the third electrode 32 correspondingly change attributes of the connected electrodes.

In this way, the detector 100 may select a proper electrical polarity of the second electrode 23 according to different target components, so that the aerosol granules containing the target component carry proper charges, which helps detection.

In some embodiments, the detector 100 further includes a limiting member 70, and the limiting member 70 is disposed between the charging cavity 21 and the separation cavity 31 in a blocked manner and provided with a limiting through hole 71 communicated with the charging cavity 21 and the separation cavity 31.

It may be understood that the detection gas flow can enter the separation cavity 31 through the limiting through hole 71 only, the limiting through hole 71 is used for limiting a position of the detection gas flow entering the separation cavity 31, and the limiting member 70 may be made of an insulation material.

In this way, the detection gas flow may enter the trap electric field at a proper position and angle by reasonably configuring the position of the limiting through hole 71, thereby reducing the probability of the charges being transferred due to collision with the third electrode 32 caused by the flow of the gas flow itself, which helps reduce charge losses and improve the sensitivity of the detector 100.

In some embodiments, the limiting member 70 is provided with a flow guide channel 72, the flow guide channel 72 is at least partially tapered in the flow direction of the detection gas flow, and the limiting through hole 71 is formed at a tail end of the flow guide channel 72 in the flow direction.

In other words, the flow guide channel 72 is of a trumpet shape. A position with a maximum flow area is communicated with the charging cavity 21, and a position with a minimum flow area is provided with the limiting through hole 71 and communicated with the separation cavity 31. Specifically, the limiting member 70 may be disposed in the cylinder 60, with one end facing the charging cavity 21 and having the same diameter as the charging cavity 21, and the other end facing the separation cavity 31.

In this way, the detection gas flow may enter the charging cavity 21 under the guidance of the flow guide channel 72. Under the action of the tapered flow guide channel 72, the detection gas flow may be more concentrated and kept away from the third electrode 32, thereby reducing the probability of direct or rapid collision with the third electrode 32 due to being excessively close to the third electrode 32 during flow.

Specifically, the attribute of the electrode connected to the fourth electrode 33 is the same as the attribute of the charges carried by the detection gas flow after charging, the flow guide channel 72 is disposed along the axis of the cylinder, and an axis of the limiting through hole 71 coincides with the axis of the cylinder.

In some embodiments, the electrostatic detection mechanism 40 includes a charge capturing structure (not shown in the figure), and the charge capturing structure is a metal powder sintered filter element.

The charge capturing structure is connected downstream of the ion trap 30. The detection gas flow output from the ion trap 30 is introduced into the charge capturing structure, and after the charged particles are in contact with the charge capturing structure, the charges are transferred to the charge capturing structure to be detected.

The metal powder sintered filter element has the advantages of a large conductive area and corrosion resistance. The structure itself has a certain thickness and is more stable, which does not require additional external support or filling. The hole size formed by sintering metal powder may be set as required. In addition, the metal powder sintered filter element further has the advantages such as a mature industrial chain and easy availability.

Specifically, the charge capturing structure may be formed by sintering metal powder such as stainless steel, titanium, copper, Monel, Hastelloy, and aluminum, and may be sintered to form a filter element with the hole size ranging from 0.1 micrometers to 500 micrometers as required. It may be understood that in some other embodiments, the charge capturing structure may further be a metal grid.

According to the above detector 100, the atomization mechanism 10 introduces the carrier gas and atomizes the sample to form the detection gas flow. The detection gas flow flows downstream, enters the charging cavity 21 in the charging mechanism 20 after being dried by the drying tube 50, is located between the first electrode 22 and the second electrode 23, and is charged under the discharging of the first electrode 22 and the second electrode 23. The charged detection gas flow can continue to flow along the cylinder 60, be gradually concentrated under the guidance of the flow guide channel 72 of the limiting member 70, pass through the limiting through hole 71 to flow into the separation cavity 31 along the axis of the cylinder 60, and be located between the third electrode 32 and the fourth electrode 33. The charged carrier gas molecules collide with the third electrode 32 under the action of the trap electric field between the third electrode 32 and the fourth electrode 33, the charges of the carrier gas molecules are transferred, and the carrier gas molecules revert to neutral molecules. According to another aspect, the charged aerosol granules containing the target component can follow the neutral carrier gas to successfully pass through the ion trap 30 and finally flow to the electrostatic detection mechanism 40. The detection gas flow entering the electrostatic detection mechanism 40 enters the metal powder sintered filter element, the charged aerosol granules containing the target component collide with the metal powder sintered filter element, and the charges carried by the charged aerosol granules are transferred to the metal powder sintered filter element to be detected.

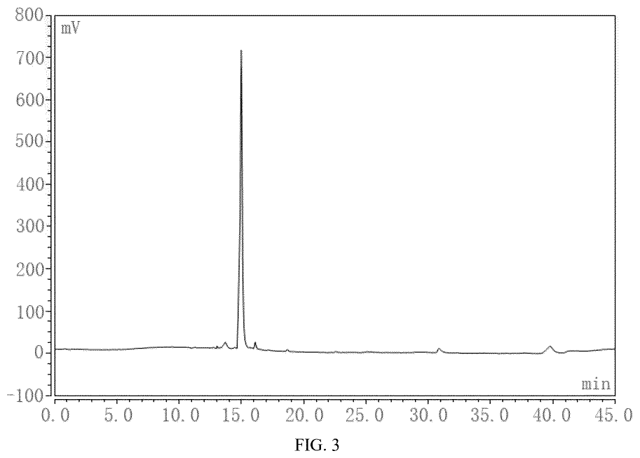

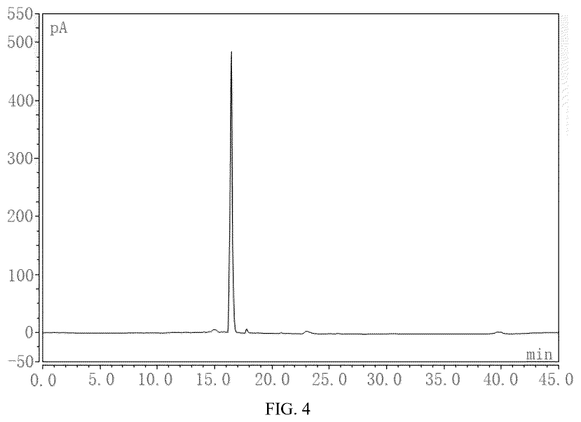

Referring to FIG. 3 and FIG. 4, in an example of a sample with the target component being fatty acid, the detector 100 and the detection solution in the related art perform analysis testing on the same sample under the same chromatographic condition, and the results are as follows: in a main chromatogram of the detection solution in the related art, a peak height is 480 mV, and a peak area is 107.7764 mV·min; and in a chromatogram of the detector 100, a peak height is 720 mV, and a peak area is 162.5 mV min. It may be known that the detector 100 increases the peak height response by approximately 50% and the peak area response by approximately 51%.

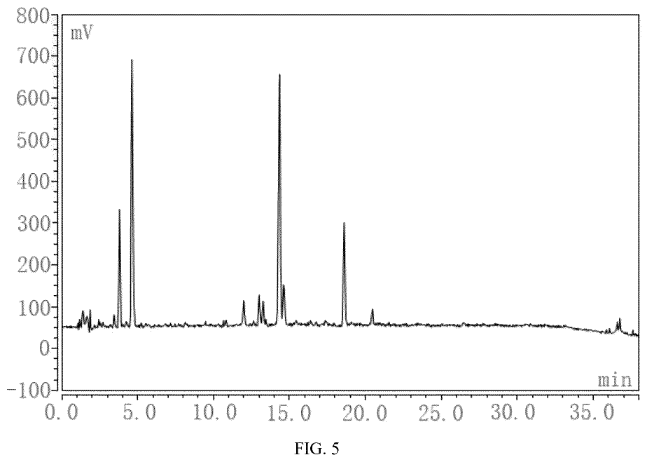

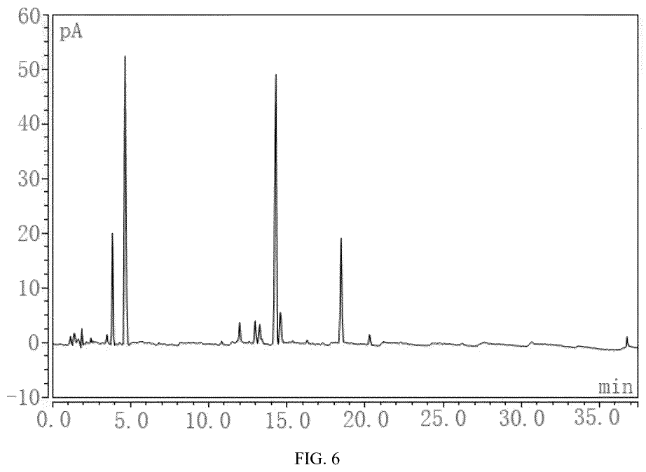

Referring to FIG. 5 and FIG. 6, in an example of a sample with the target component being notoginsenoside, the detector 100 and the detection solution in the related art perform analysis testing on the same sample under the same chromatographic condition. The results show that the detector 100 achieves a peak height of 890 mV compared to 620 mV for the conventional detector, representing a 44% improvement in sensitivity. The peak area increases from 145.2 mV min to 198.7 mV·min, demonstrating a 37% enhancement in overall response.

The technical features of the above embodiments can be combined in any way. To simplify the description, not all possible combinations of the technical features in the above embodiments are described. However, as long as there is no contradiction in the combinations of the technical features, all the possible combinations should be considered to fall within the scope of the specification.

The above embodiments only express several implementations of this disclosure, and the description thereof is relatively specific and detailed but should not therefore be construed as limiting the patent scope of this disclosure. It should be noted that without departing from the concept of this disclosure, those of ordinary skill in the art may further make several variations and improvements, which shall all fall within the protection scope of this disclosure. Therefore, the protection scope of the patent of this disclosure shall be subject to the appended claims.

What is claimed is:

1. A detector, comprising:
an atomization mechanism (10), provided with an atomization cavity (11) and used for introducing a carrier gas and atomizing a sample, to form, in the atomization cavity (11), a detection gas flow containing an atomized sample;
a charging mechanism (20), disposed downstream of the atomization mechanism (10) along a flow direction of the detection gas flow, provided with a charging cavity (21), and configured to be capable of charging the detection gas flow in the charging cavity (21);
an ion trap (30), disposed downstream of the charging mechanism (20) along the flow direction of the detection gas flow, provided with a separation cavity (31), and used for separating charges carried by the carrier gas and solvent molecules in the detection gas flow in the separation cavity (31); and
an electrostatic detection mechanism (40), disposed downstream of the ion trap (30) along the flow direction of the detection gas flow, communicated with the separation cavity (31), and used for detecting a quantity of charges carried by the detection gas flow that is output from the ion trap (30) and that contains a target component, wherein
the atomization cavity (11), the charging cavity (21), and the separation cavity (31) are sequentially connected and communicated, to jointly form a detection gas path for the detection gas flow to flow.

2. The detector according to claim 1, wherein the charging mechanism (20) comprises a first electrode (22) and a second electrode (23), the first electrode (22) encloses to form the charging cavity (21), and the second electrode (23) is at least partially disposed in the charging cavity (21) and is spaced apart from the first electrode (22).

3. The detector according to claim 2, wherein the ion trap (30) comprises a third electrode (32) and a fourth electrode (33), the third electrode (32) encloses to form the separation cavity (31), and the fourth electrode (33) is at least partially disposed in the separation cavity (31) and is spaced apart from the third electrode (32).

4. The detector according to claim 3, wherein the detector further comprises a cylinder (60), the cylinder (60) comprises a first segment (61) and a second segment (62) in an axial direction of the cylinder, the first segment (61) is formed as the first electrode (22), and the second segment (62) is formed as the third electrode (32).

5. The detector according to claim 4, wherein the cylinder (60) is of a cylindrical shape, and the second electrode (23) and the fourth electrode (33) are both needle electrodes or rod electrodes and are both disposed along an axis of the cylinder (60).

6. The detector according to claim 4, wherein the detector is configured to selectively introduce positive or negative charges to the second electrode (23) and the fourth electrode (33).

7. The detector according to claim 1, wherein the detector further comprises a limiting member (70), and the limiting member (70) is disposed between the charging cavity (21) and the separation cavity (31) in a blocked manner and provided with a limiting through hole (71) communicated with the charging cavity (21) and the separation cavity (31).

8. The detector according to claim 7, wherein the limiting member (70) is provided with a flow guide channel (72), the flow guide channel (72) is at least partially tapered in the flow direction of the detection gas flow, and the limiting through hole (71) is formed at a tail end of the flow guide channel (72) in the flow direction.

9. The detector according to claim 1, wherein the electrostatic detection mechanism (40) comprises a charge capturing structure, and the charge capturing structure is a metal powder sintered filter element.

10. The detector according to claim 1, wherein the detector further comprises a drying tube (50), and the drying tube (50) is disposed between the atomization mechanism (10) and the charging mechanism (20), communicated with the atomization cavity (11) and the charging cavity (21), and used for drying the detection gas flow flowing through the drying tube.
